(19) United States
(12) Patent Application Publication
(10) Pub. No.: US 2013/0054239 A1
(43) Pub. Date: Feb. 28, 2013

(54) System, Method and Computer Program Product for Dataset Authoring and Presentation with Timer and Randomizer

(71) Applicant: Benjamin Z. Levy, Weston, FL (US)

(72) Inventor: Benjamin Z. Levy, Weston, FL (US)

(21) Appl. No.: 13/589,429

(22) Filed: Aug. 20, 2012

Related U.S. Application Data
(60) Provisional application No. 61/527,075, filed on Aug. 24, 2011.

(51) Int. Cl. G10L 15/26

(52) U.S. Cl. 704/235; 704/E15.043

(57) ABSTRACT

A system, method and computer program product for authoring and presenting discrete data elements and datasets on any computing device are described. Said datasets can comprise of typed, entered or speech-converted text, numbers, images, and sounds. Said system and method feature a user-controlled timer that can be set in intervals of one or more milliseconds and can be used to display said data elements in said dataset in succession. Another feature described is a randomizer which can present said data elements in said dataset in an unpredictable and random order.

### CROSS REFERENCE TO RELATED APPLICATIONS

This application claims the benefit of provisional patent application Ser. No. 61/527,075, filed 2011 Aug. 24 by the present inventors, entitled “Digital True Information Presentation System,” the entirety of which is hereby incorporated by reference herein.

### FEDERALLY SPONSORED RESEARCH

Not applicable

### SEQUENCE LISTING OR PROGRAM

Not applicable

### FIELD OF THE INVENTION

The present invention relates generally to educational computer applications, and more particularly relates to educational computer applications for authoring and presenting data such as text, numbers, images, and sounds, utilizing a timer and randomizer, for the purpose of teaching language, math, music and general knowledge to learners of all ages.

### BACKGROUND OF THE INVENTION

### Prior Art

It has been observed that babies learn their native language without anyone formally teaching it to them. They simply pick it up without formal instruction or the use of dictionaries, computers or videos. Babies hear words spoken to them directly and indirectly, and assign meaning to the various sounds they hear. Through repetition and continued listening, they build a knowledge base of words and phrases and they are even able to derive grammatical rules and exceptions from this informal method. Babies are usually exposed to spoken language from day one and their exposure to spoken language continues repeatedly throughout every day from then on. The baby is not expected to speak or prove that they understand, but the parents keep on exposing them to spoken language anyway. What about exposing babies to written language, simple mathematical concepts, and other facts?

It has been researched and proven that an informal and repeated exposure to written language, similar to spoken language, results in babies learning to read language and understand it in much the same way they can hear language and understand it. The difference is merely that spoken language enters the brain through the auditory pathway, and written language enters the brain through the visual pathway. The Institutes for the Achievement of Human Potential, based in Pennsylvania and headed by Glenn Doman, has done extensive research spanning over half a century on human brain development, and their research has shown that babies want, and should, learn to read. It's as easy for babies to pick up written language as it is for them to pick up spoken language. Additionally, the Institute's research has shown that there is an optimal window of opportunity for knowledge acquisition that exists in babies from birth to 6 years of age, where the rate of said knowledge acquisition is extremely high. In this stage, babies want to be shown new facts as quickly as they're able to absorb them, which is generally quicker than most parents or teachers can deliver. After 6 years old, the baby's brain is fully grown and the rate at which they acquire new information is slower.

Parents speak to their babies constantly, but rarely do they expose their babies to written language purposefully. The main reason for this is that it's much easier to speak than to write. One's voice is free and portable, whereas one needs tools with which to write and materials to write on. Additionally, because repetition is a necessary component in teaching language, the degree of difficulty is multiplied between speaking and writing. Another reason is portability. A parent takes their voice with them anywhere, whereas writing tools are harder to have on hand at all times. If parents want to expose their babies to both spoken and written language during the above mentioned optimal window of opportunity, they will need a system or tool that will facilitate this endeavor.

Along with language, babies can easily absorb other facets of human knowledge, such as mathematics, art, music, science, history, and culture, provided they are given the opportunity and proper exposure, meaning clear representation of facts in a distraction-free environment and reinforced by repetition. The aforementioned Institutes for the Achievement of Human Potential developed a system and created a collection of paper-based products that enable parents to teach their babies how to read, do math, and acquire general knowledge through images. Their products have met with much success, but have several drawbacks. Among them are cost, susceptibility to wear and tear, and physical size and weight, making portability and rapid presentation challenging.

There are many products available in the general marketplace designed to aid in the effort of teaching language, numbers and other facts to the young and very young. There are books, television programs, DVDs, computer programs, and educational games and websites. For example, Sesame Street R TM was a big hit with parents and children, and is still popular today because of it's educational and entertainment value and because the material covered is factual and doesn't change with the times. Numerals and letters of the alphabet are a major part of the core curriculum being presented with the help of very colorful and entertaining characters. There are computer programs like Reader Rabbit R TM and video-based programs such as Your Baby Can Read R TM that are marketed to parents with young children with varying degrees of success. However, the aforementioned methods and products and other prior art in the field of early education have several major drawbacks and shortcomings.

Firstly, the prior art is intended for the baby or child to learn the material on their own, with little to no parental guidance or involvement, whereas when learning spoken language, parents are the main teachers. Secondly, the prior art is not aimed at or designed for newly born babies who are acquiring spoken language skills. Thirdly, the entertainment component found in the prior art greatly distracts from the educational component. Fourthly, the parent has little or no control over the educational content found in the prior art. Additionally, the material in the prior art appears in the same exact order each time it is played or used, and at the same exact speed.

Due to these and other shortcomings of the prior art, there is a need for a system and method to be invented and created which will facilitate authoring and presenting basic language, math and other knowledge to babies in a distraction-free environment. This system and method should address all the disadvantages mentioned in the prior art, and at the same time be portable and affordable.

### OBJECTS AND ADVANTAGES

The disadvantages of the prior art are substantially overcome by the computer-based system of the present invention, which provides a suite of authoring and presentation tools. The system and method described is designed to facilitate authoring and presenting unambiguous facts to audiences of any age, including newborns, and to be affordable, portable, and accessible on any computing device. This system can be used by a parent or teacher, can be accessed from any computing device, such as PCs, smartphones and tablets, and can be presented to one or more learners at a time. The invention provides the parent or teacher with a robust ability to create a wide variety of datasets, which may include words, numbers, images and sounds, and to control parameters of the presentation of said datasets, for the benefit of the learner or learners.

According to one aspect of the invention, the user can present datasets in random or known order. In this way, each presentation can be unique, even if the material in the datasets is the same. Showing facts in a random and unpredictable manner is useful because each discrete fact is perceived for what it is and not for it's memorized place in a list.

According to another aspect of the invention, the user can choose between automatic and manual presentation modes. The manual mode requires user action between elements of a dataset. Automatic mode applies a user-selected time interval between elements of a dataset. In this way, the user has control and flexibility over every presentation. This aspect is useful because it allows the parent or teacher the option to elaborate and expand upon each discrete fact in their own time.

According to another aspect of the invention, the user can present datasets at a variety of speed levels. Elements of a dataset can be shown at a rate of up to 1000 elements per second. This ensures that datasets can be presented faster than is manually possible and therefore such presentations are more suitable to accommodate the knowledge acquisition rate of any age learner, including the newly born. The timer aspect is useful because it allows the parent or teacher to expose discrete facts and general information in a more efficient way.

According to another aspect of the invention, most elements in most datasets are presented visually, while simultaneously relying on the voice of the parent or teacher for identifying said elements. In the preferred embodiment, this aspect is vital to the success of the educational program because babies respond to the sound of their parent's voice better than any recorded voice. This aspect also helps retain the baby's interest throughout the program.

According to another aspect of the invention, elements in a dataset are shown in the most unambiguous and distraction-free way possible. In the preferred embodiment, each word, for example, is shown centered, in a font size that allows the word to fit the width of the screen, while all controls and user-interface elements are completely removed. Said controls are brought back at the end of the dataset presentation. In this way, all focus is placed on each discrete element as they're being presented for better absorption and retention. Isolating facts from distracting elements is useful because it eliminates ambiguity and gives proper definition and clarity to each discrete fact presented.

According to one aspect of the preferred embodiment of the invention, words may be authored and presented as single words, couplets, short phrases and sentences. This allows the creation of a reading program that better prepares the learner for more practical reading.

In another aspect of the preferred embodiment of the invention, font, size, and color of words are customizable. This is useful because it provides the parent or teacher with the ability to change characteristics of a fact without changing the fact itself. For example, a word written in red means the same as that same word written in black, and a word with a size of 20 pixels means the same as that same word with a size of 12 pixels.

In another aspect of the preferred embodiment of the invention, extensive lists of words are provided to insure correct spelling and to save authoring time. Another use of this aspect is that it allows the parent or teacher to include words in their authoring that they might not have included otherwise.

In another aspect of the preferred embodiment of the invention, numbers and quantities are shown as copies of an image placed in random screen locations, and not as numerals. In this way, quantities can be perceived based on the number of copies present on the screen and can be compared to other quantities visually rather than abstractly as when using numeral symbols.

In another aspect of the preferred embodiment of the invention, the user can specify and select any range of numbers quickly and efficiently using a slider, which saves authoring time.

In another aspect of the preferred embodiment of the invention, simple mathematical equations can be generated using numbers inside a selected range, which saves authoring time.

In another aspect of the preferred embodiment of the invention, testing the learner is provided for. A choice is presented to the learner between the correct fact and one or more incorrect facts.

In the preferred embodiment of the invention, each element of each dataset that was presented is stored in a database. The information stored can later be used in reports designed to let the user better keep track of their educational program.

The above and other features of the invention including various novel details and other advantages, will now be more particularly described with reference to the accompanying drawings and pointed out in the claims. It will be understood that the particular method and embodiment of the invention are shown by way of illustration and not as a limitation of the invention. The principles and features of this invention may be employed in various and numerous embodiments without departing from the scope of the invention.

### SUMMARY OF THE INVENTION

A system, method and computer program product for authoring and presenting discrete data elements and datasets on any computing device are described. Said datasets can comprise of typed, entered or speech-converted text, numbers, images, and sounds. Said system and method feature a user-controlled timer that can be set in intervals of one or more milliseconds and can be used to display said data elements in said dataset in succession. Another feature described is a randomizer which can present said data elements in said dataset in an unpredictable and random order.

### DRAWINGS—FIGURES

For the present invention to be clearly understood and readily practiced, the present invention will be described in conjunction with the following figures wherein:

FIG. 1 is a flow diagram showing the major steps of the method of the invention, illustrating the manner by which a dataset is presented using the timer and randomizer in accordance with the present invention.

FIG. 2 is a flow diagram for illustrating the manner by which the timer feature is employed in the present invention.

FIG. 3 is a flow diagram for illustrating the manner by which the randomizer feature is employed in the present invention.

### DETAILED DESCRIPTION OF THE INVENTION—FIGS.

The present invention is a computer based system. As such, it consists of a set of computer instructions, stored as a program in a computer memory and executable on a computer processor. The system can be implemented on any type of computer, including a personal computer, smartphone, tablet, or any other computing device. According to the preferred embodiment of the invention, the system is implemented on a server computer connected to a global network, such as the Internet. A client computer, having a browser program, can access the dataset authoring and presentation system program of the present invention on the server computer for execution at a remote location. Furthermore, the program implementing the system of the present invention may be created in any known modern computer language, such as C or JavaScript. Those of ordinary skill in the art of computer programming will readily understand how to create a program having the functionality of the present invention as discussed below.

To illustrate how a computer programmer of average skill may recreate the system and method herein described, we will use HTML for user-interface element creation and JavaScript and PHP for scripting. AJAX is used to communicate with a server, the results of which show up on the same HTML page. JQuery is used as the preferred JavaScript library. A folder or directory is created for each user to store and retrieve their datasets, hereinafter referred to as User Folder. A dataset is defined as an array that contains discrete elements of information, such as words, numbers, images and sounds.

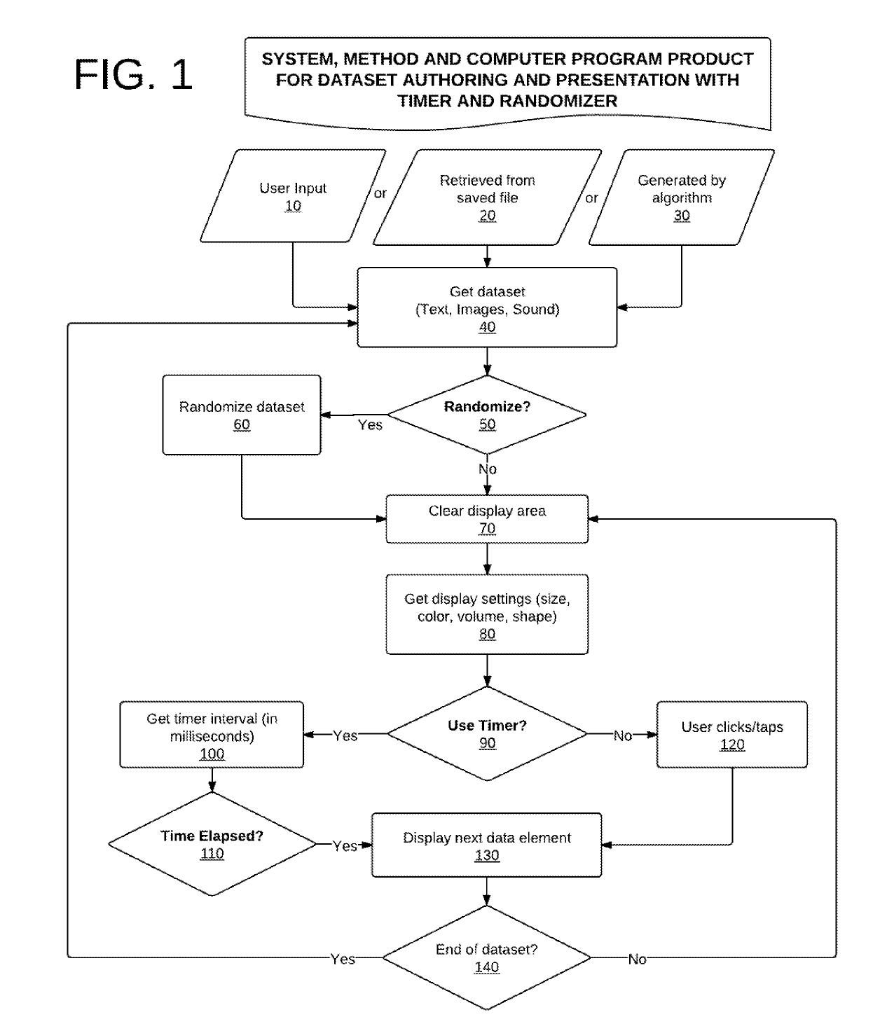

FIG. 1 is a flow diagram showing the major steps of the method of the invention, illustrating the manner by which a dataset is entered 10, selected 20, or generated 30 by the user and after dataset is received 40, said dataset is presented using the randomizer 50 and timer 90.

To allow users to enter lists of data elements 10, a <TEXTAREA> element may be used. To allow users to choose from a list of saved datasets 20, the contents of the User Folder may be made available in a <SELECT> element using AJAX and PHP, and the chosen dataset can then be read into the <TEXTAREA> element. To allow users to generate a dataset 30, dataset creating controls and rules are used. For example, in one embodiment of the invention, two sliders, one for minimum and one for maximum, can be used to delimit a range of numbers, such as 1 through 5, and a dataset will be generated with five data elements 1, 2, 3, 4, 5 in ascending mode or 5, 4, 3, 2, 1 in descending mode.

The objects that have been authored 10, retrieved 20, or generated 30 are processed thusly: they are split by a separating character, such as a comma or return character, and stored in an array 40, which is referred to as “dataset” throughout this application.

In an embodiment of the invention, presentation controls are initially visible as <INPUT> elements inside a <DIV> element and are used to manipulate variables that control appearance and presentation 80. Settings such as font, size, color and volume may be set by the user and stored as global variables that are available to the presentation function 80. All presentation controls should have default values that ensure proper functionality of the presentation function 80.

In an embodiment of the invention, a <BUTTON> element with an “onclick” pointing to the presentation function 80 may be used to start the presentation, at which point the <DIV> element containing the presentation controls is cleared for the duration of the presentation using a JQuery “hide” command 70. Clearing the presentation controls <DIV> is done for the purpose of providing a distraction-free display area for presenting discrete data elements.

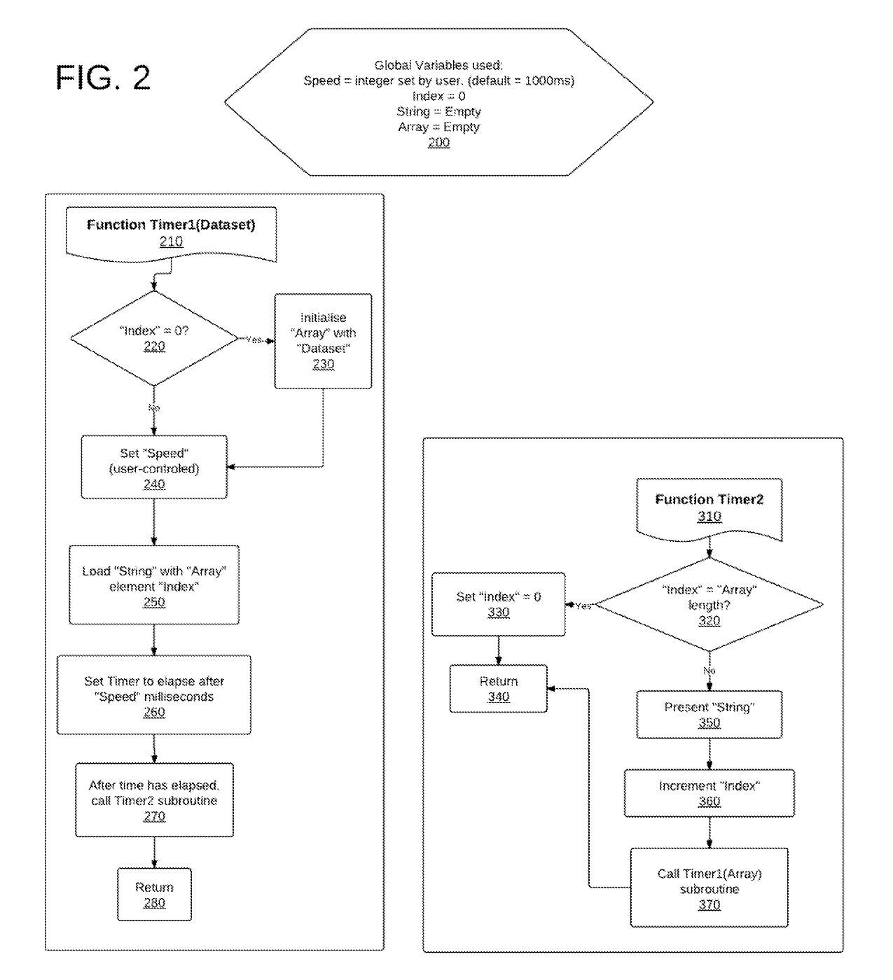

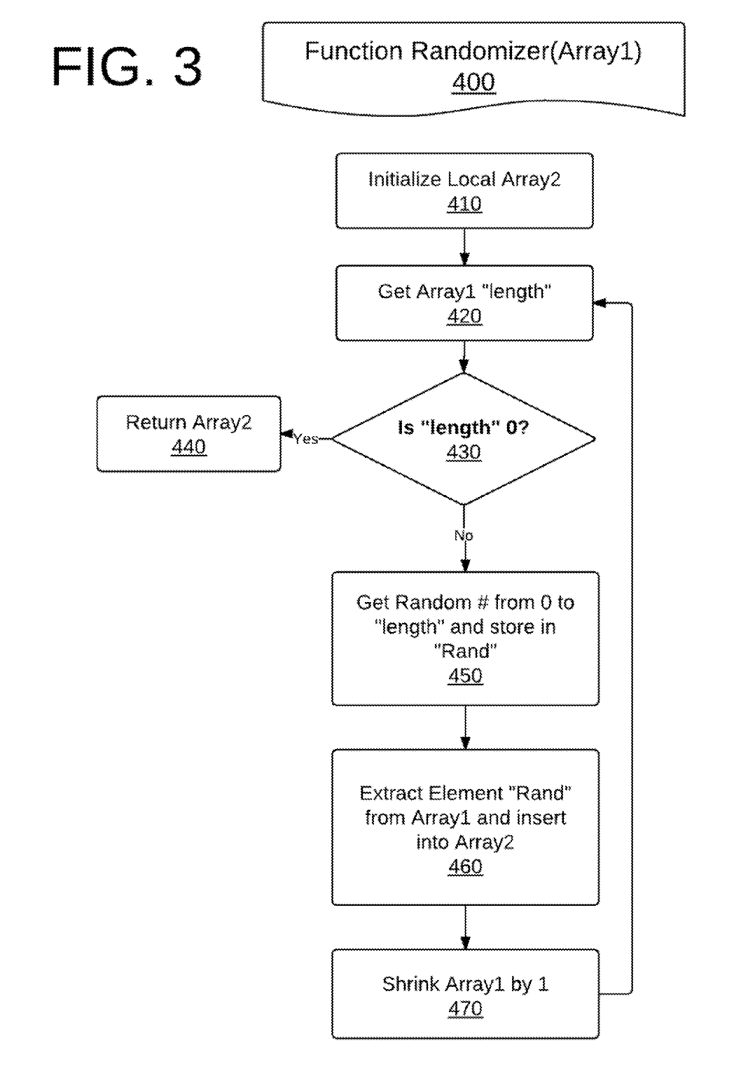

The presentation controls most essential to the present invention are the Randomizer checkbox 50 and the Automatic checkbox 90. The Randomizer checkbox 50 controls whether datasets are displayed in their original order or in random order. The randomizing algorithm is described in more detail in FIG. 3. The Automatic checkbox 90 controls whether to apply a user selected time interval 100 that will elapse between presenting each element in the dataset 110, or to wait for a user-action, such as a mouse click, key press, or touch-screen tap, to occur between presenting each discrete data element in the presentation 120. In one embodiment of the invention, a “timer knob” may be used to set the number of milliseconds in the speed variable, which is applied in the timer function of the invention, discussed in more detail in FIG. 2.

The presentation of each discrete data element may take place inside the display area using JavaScript's “innerHTML” command 130. As long as there are elements in the dataset remaining to be presented 140, each element replaces the previously displayed element 70 so that each can be shown discretely. In an embodiment of the invention, once every element in a dataset has been presented, the presentation controls <DIV> is made visible using a JQuery “show” command.

FIG. 2 is a flow diagram illustrating the manner by which the timer feature 90 in FIG. 1 is employed in the present invention.

A set of global variables 200 is initialized thusly: “Speed” is a user-defined variable containing the number of milliseconds 110 in FIG. 1, with the default value set to 1000 in an embodiment of the invention. “Index” is a variable that is initialized to 0 and is used to address each discrete element in the dataset. In an embodiment of the invention, “String” starts as an empty string and is used to contain CSS-styled HTML surrounding the current data element being presented, and “Array” starts as an empty array used to contain the data elements in the dataset passed as an argument “Dataset” to the function Timer1 210.

In an embodiment of the invention, there are two related Javascript functions 210 and 310, labeled Timer1 and Timer2 respectively. Timer1 is called with one argument labeled “Dataset”, which points to an array containing the data elements to be presented.

When Function Timer1 210 is called 90 in FIG. 1, global variable “Index” is 0 220, indicating that the presentation is at the beginning and global variable “Array” is loaded with “Dataset” elements 230. In an embodiment of the invention, the JavaScript command setTimeout is used with two arguments: one is a callback function, Timer2 310, and one is global variable “Speed” 240. Global variable “String” contains the HTML tags surrounding the current dataset element in “Array” pointed to by “Index” 250. The JavaScript command setTimeout is called 260 and is set to elapse after “Speed” milliseconds, at which point the callback function Timer2 310 gets called 270. After presenting all data elements, the function Timer1 210 returns 280.

Function Timer2 310 gets called after “Speed” milliseconds have elapsed and it's purpose is to cause the current data element to be presented 350 and increment the global variable “Index” 360. If “Index” is equal to “Array” length 320, “Index” is initialized to 0 330 and the function returns 340. If “Index” is less than “Array” length 320, the presentation takes place using “String” 350, “Index” is incremented 360, and the function Timer1 is called with the argument “Array” 370. At the point when Timer2 310 calls Timer1 210, “Index” is a positive integer, not 0, and therefore Timer1 does not initialize “Array” 230.

FIG. 3 is a flow diagram illustrating the manner by which the randomizer feature 50 in FIG. 1 is employed in the present invention.

When the Randomizing option is selected, the function Randomizer is called with one argument labeled “Array1” 400 which points to an array containing the data elements in the dataset to be presented. A local array labeled “Array2” is established and initialized 410. The number of elements contained in “Array1” is stored in a local variable labeled “length” 420.

Randomizing is achieved by moving random elements from Array1 and placing them into Array2. In more detail, a random integer between 0 and “length” is requested using the JavaScript “Math.rand” method and stored in a local variable labeled “Rand” 450. In an embodiment of the invention, “Rand” is used as an index for elements in “Array1”. The data element being pointed to by “Rand” is pushed into “Array2” 460, and extracted from “Array1” 470 using the JavaScript “splice” method, thereby shrinking the number of remaining elements in “Array1”, which is stored in “length” 420.

When all elements of the dataset have been extracted from “Array1” and pushed into “Array2” in this fashion, “length” becomes 0 430 and “Array2” is returned to the caller 440, thereby returning a shuffled and randomized dataset ready for presentation.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

### CONCLUSION, RAMIFICATIONS, AND SCOPE

Accordingly the reader will see that, according to the invention, we have provided a novel system and method to easily create and display dynamic presentations of data such as words, numbers, images, and sounds in a discrete and distraction-free manner.

While the above description contains many specificities, these should not be construed as limitations on the scope of the invention, but rather as exemplifications of the presently preferred embodiments thereof Many other ramifications and variations are possible within the teachings of the invention. For example, the present invention can be used in an application designed to test a user's memory and their ability to access and retrieve information presented to them. The present invention can also be used in applications designed to test a user's Intelligence Quotient, or IQ.

Thus the scope of the invention should be determined by the appended claims and their legal equivalents, and not by the examples given.

What is claimed is:

1. A system and method operating on a computing device comprising:
a means of visually and/or audibly displaying data;
a means for timing milliseconds; and
a means for storing and retrieving data,
said system and method which upon receiving a dataset comprising of more than one element authored, generated, or retrieved by the user, will either leave said dataset in order that it was received, or arrange the elements in said dataset randomly and either wait for a time interval of one millisecond or more to elapse, or wait for a user action to take place before presenting the next element in said dataset in a discrete and distraction-free manner.

2. The system and method according to claim 1, wherein said dataset may be authored in real time or retrieved from a variety of sources comprising:
direct user-input, such as text entered by means of a physical or virtual keyboard or speech-to-text system;
a saved file containing previously entered data, such as text, numbers, images, or sounds; or an algorithm designed to generate data in accordance with user-directed parameters.

3. The system and method according to claim 2, wherein the elements of said dataset do not require additional formatting or processing.

4. The system and method according to claim 1, wherein the user can choose the time interval between presenting data elements.

5. The system and method according to claim 1, wherein the user can choose whether or not to randomize said dataset.

6. The system and method according to claim 1, wherein the user can choose between an automatic presentation using a time interval between said data elements or a presentation requiring user action between said data elements.

7. The system and method according to claim 1, wherein a single data element may be presented in the same manner as said dataset containing more than one data element.

8. The system and method according to claim 1, wherein each data element is displayed discretely and unambiguously on the screen of said computing device.
